(19) United States
(12) Patent Application Publication
(10) Pub. No.: US 2003/0095651 A1
(43) Pub. Date: May 22, 2003

(54) System and method for routing terminating calls to voice mail

(75) Inventors: Nancy Ann Book, Naperville, IL (US); Carol Shifrin Gruchala, Naperville, IL (US); Susanne Marie Crockett, Buffalo Grove, IL (US); Dianna Inara Tiliks, Elk Grove, IL (US); John Wesley Moss, Lake Zurich, IL (US); Thomas Joseph McBlain, Arlington Heights, IL (US)

Correspondence Address: GREENBLUM & BERNSTEIN, P.L.C., 1950 ROLAND CLARKE PLACE, RESTON, VA, 20191, US

(73) Assignee: SBC TECHNOLOGY RESOURCES, INC., Austin, TX

(21) Appl. No.: 09/987,870

(22) Filed: Nov. 16, 2001

(51) Int. Cl. H04M 3/42

(52) U.S. Cl. 379/211.01

(57) ABSTRACT

A service controls routing of incoming calls to a subscriber's voice mail system by forwarding a call to the subscriber's telephone from a terminating switch through a telecommunications network to an intelligent peripheral, based on instructions from a service control point. The intelligent peripheral queries the caller to select options, including leaving a message, paging the subscriber, and providing a personal identification number (PIN) to connect the call to the subscriber telephone. When leaving a message is selected, the intelligent peripheral connects the call to the voice mail system. When paging is selected, the intelligent peripheral obtains a call back number, disconnects the call and places a second call to the paging system. When connecting the call using a PIN is selected, the intelligent peripheral queries the caller to enter the PIN and, upon receiving an authorized PIN, connects the call to the subscriber telephone via the terminating switch.

### BACKGROUND OF THE INVENTION

1. Field of the Invention

The present invention relates to the field of telecommunications. More particularly, the present invention relates a service that enables a subscriber to route terminating calls to voice mail, bypassing the subscriber's line without ringing the subscriber's telephone. The present invention further relates to enabling the calling party optionally to bypass the voice mail by entering a personal identification number or to automatically page the subscriber.

2. Acronyms

The written description provided herein contains acronyms which refer to various telecommunications services, components and techniques, as well as features relating to the present invention. Although some of these acronyms are known, use of these acronyms is not strictly standardized in the art. For purposes of the written description herein, the acronyms are defined as follows:

Advanced Intelligent Network (AIN)

Central Exchange Service (Centrex)

Central Office (CO)

Dual Tone Multi-Frequency (DTMF)

Electronic Key Telephone System (EKTS)

Flexible Call Forwarding (FCF)

Graphical User Interface (GUI)

HyperText Mark-Up Language (HTML)

HyperText Transfer Protocol (HTTP)

Incoming Call Manager (ICM)

Internet Caller Identification (ICID)

Interactive Voice Response (IVR)

Outgoing Call Control (OCC)

Personal Computer (PC)

Personal Call Manager/Personal Communications Manager (PCM)

Personal Identification Number (PIN)

Plain Old Telephone Service (POTS)

Private Branch Exchange (PBX)

Public Switched Telephone Network (PSTN)

Secure Sockets Layer (SSL)

Service Control Point (SCP)

Service Management System (SMS)

Service Node/Intelligent Peripheral (SN/IP)

Service Switching Point (SSP)

Signaling System 7 (SS7)

Signaling Transfer Point (STP)

Terminating Attempt Trigger (TAT)

Transmission Control Protocol/Internet Protocol (TCP/IP)

Two B Channel Transfer (TBCT)

Uniform Resource Locator (URL)

World Wide Web (WWW)

3. Background Information

Telephones have become a practical necessity in today's society, from both personal and professional perspectives. Telephone calls exchanged in the course of daily activities assist in enabling the convenience and efficiency of modem living. However, telephone calls likewise may become disruptive to families and businesses alike, when they are excessive or poorly timed. However, because of the growing reliance on timely and often immediate communication of information, especially in emergency situations, it may be imprudent for a called party to simply block or ignore incoming telephone calls.

Conventional automated voice mail services provide partial solutions, enabling a calling party to at least leave a voice message explaining the purpose of the telephone call. The voice mail customer is then able to retrieve the message at his or her convenience, make an informed decision regarding the importance of the call and return the call as deemed appropriate. Voice mail services have a number of drawbacks, however. For example, the incoming calls are connected to the customer's telephone, often ringing the customer's telephone a predetermined number of times, prior to enabling the voice mail. Although useful for notifying the customer of an incoming call and potential voice message, the ringing is disruptive to the customer at the receiving end and frequently unwelcome.

Voice mail services that optionally block the ringing tone of the customer's telephone have their own drawbacks. For example, when there is no ringing tone, the customer is not on notice of the attempted call or that a message may have been recorded as a result. Also, the customer may forget to re-activate the ringing, causing it to remain off indefinitely. Furthermore, the calling party is not necessarily aware that the ringing has been deactivated by the customer because the ringing tone is still audible over the calling party's handset, possibly causing the calling party to incorrectly conclude that the customer is not in.

The customer may also want to receive priority calls from certain people, but conventional voice mail services do not provide an indication of desirable versus undesirable calls. To screen a call, the customer must therefore resort to waiting for the voice mail service to record a message, access the voice mail to hear the message and determine, after the fact, whether it was a call he or she had wanted to take. Even if the customer also subscribes to a caller ID service, screening is only effective to the extent the priority call is placed from a recognizable telephone number.

If the customer also subscribes to a paging service, he or she can still be contacted even when the calling party has reached a voice mail service and the customer has not yet collected messages. Paging services, however, require the calling party to dial a separate telephone number, which requires knowledge of the number and possible repeat toll charges for placing a second call. The customer may provide the page number as part of the voice message played by the voice mail service for the calling party's convenience, but the problems of the calling party needing to memorize the number and possibly incur additional charges remain.

The present invention overcomes the problems associated with the prior art, as described below.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 is a block diagram showing an exemplary telecommunications network for the call routing service, according to an aspect of the present invention;

FIG. 2 is a flowchart of exemplary SCP service logic for the call routing service, according to an aspect of the present invention;

FIG. 3 is a flowchart of exemplary service node-intelligent peripheral service logic for the call routing service, according to an aspect of the present invention;

FIG. 4 is an exemplary call routing service call flow diagram showing routing an incoming telephone call to a subscriber's voice mail, according to an aspect of the present invention;

FIG. 5 is an exemplary call routing service call flow diagram showing routing to a subscriber's paging service in response to an incoming call to the subscriber's terminal, according to an aspect of the present invention;

FIG. 6 is an exemplary call routing service call flow diagram showing bypassing a subscriber's voice mail by entering a personal identification number, according to an aspect of the present invention;

FIG. 7 is an exemplary call flow diagram in which the subscriber accesses the call routing service via the Internet, according to an aspect of the present invention;

FIG. 8 is an exemplary web page to be displayed at the subscriber's GUI for creating, editing and deleting activation schedules for call routing, according to an aspect of the present invention; and

FIG. 9 is an exemplary call flow diagram in which the subscriber accesses the call routing service via an interactive voice response system, according to an aspect of the present invention.

### DETAILED DESCRIPTION OF EMBODIMENTS

The present invention relates to an advanced intelligent network (AIN) based service that enables a subscriber to route incoming calls, terminating at the subscriber's telephone, to voice mail. The incoming calls bypass the subscriber's telephone line all together, so the subscriber's telephone does not ring. The service enables the subscriber to receive messages left by the calling party in voice mail at the subscriber's convenience.

Implementation of the call routing service is controlled by the subscriber. For example, the subscriber is able to determine when incoming calls are routed to voice mail by turning the call routing service ON and OFF, as desired, and selectively activating the service by customized time of day, day of week schedules. Furthermore, a personal identification number (PIN) is provided to enable a calling party to override the routing to voice mail of incoming calls. For example, when telephoning their own business or home, the subscriber may elect not to be sent to voice mail, connecting the call as dialed, by entering the routing bypass PIN. Alternatively, the calling party may elect to have the calling routing service automatically page the subscriber using the subscriber's previously established paging service.

The call routing service also enables the subscriber, when connected to a communications network, including the Internet and other packet switched type data networks, or to a conventional interactive voice response (IVR) system, to customize aspects of the call routing service, with near real-time access to and implementation of the service data. For example, the invention relates to implementing and editing various parameters, including, for example, the activation schedules and bypass PINs, at a web site through the Internet.

In view of the above, the present invention through one or more of its various aspects and/or embodiments is presented to accomplish one or more objectives and advantages, such as those noted below.

An aspect of the present invention provides a method for routing calls directed to a subscriber terminal in a telecommunications network. The method includes receiving call data relating to a call to a subscriber at a telephone number associated with the subscriber terminal and querying the calling party to select one of leaving a voice message, paging the subscriber and connecting the call to the subscriber terminal. The call data includes the subscriber telephone number. When the calling party selects leaving a voice message, the call is connected through the telecommunications network to a voice mail system of the subscriber. When the calling party selects paging a subscriber, call back information is received, the call is disconnected and a second call is placed through the telecommunications network to a paging system of the subscriber that initiates a page to the subscriber. When the calling party selects connecting the call to the subscriber terminal, the calling party is queried to enter a PIN. When the PIN is authorized, the call is connected to the subscriber terminal; and when the PIN is not authorized, the call is connected through the telecommunications network to the voice mail system. Also, the call may be connected to the voice mail system when no response is received to querying the calling party to select one of leaving a voice message, paging the subscriber and connecting the call to the subscriber terminal. Likewise, the call may be connected to the voice mail system when no response is received to querying the calling party to enter the PIN.

The method for routing calls directed to a subscriber terminal may further include storing at least one activation time period, including a start time and an associated stop time. Whether a time of the call is within an activation time period is determined. When the time of the call is not within an activation time period, the call is connected to the subscriber terminal without querying the calling party to select one of leaving a voice message, paging the subscriber and connecting the call to the subscriber terminal.

Another aspect of the present invention provides a method for implementing a service in a telecommunications network to control routing of calls to a voice mail service of a subscriber, bypassing a subscriber terminal, including suspending at a terminating switch in the telecommunications network a call from a calling party terminal to a telephone number of the subscriber terminal and receiving at a service control point (SCP) call data relating to the call. The call data includes the subscriber telephone number and a calling party number. When the call routing service is not active, the call is connected to the subscriber terminal. When the call routing service is active, it is determined whether the calling party number includes a telephone number of an intelligent peripheral. When the calling party number does include the intelligent peripheral telephone number, the call is connected to the subscriber terminal. When the calling party number does not include the intelligent peripheral telephone number, the call is forwarded to the intelligent peripheral, which queries the calling party to select one of paging the subscriber and bypassing the voice mail system by entering an identification number.

When no selection is received, the call is routed to the voice mail system. When the paging selection is received, a call back telephone number is received from the calling party, the call is disconnected, and a second call to a paging system of the subscriber is placed. Interaction with the paging system occurs in order to page the subscriber. When the bypassing the voice mail system selection is received, the call is routed to the subscriber terminal when the identification number entered by the calling party matches a previously determined PIN of the subscriber. The call is routed to the voice mail system when the identification number entered by the calling party does not match the PIN. The method for implementing a service in a telecommunications network to control routing of calls to a voice mail system may further include routing the call through the telecommunications network to the voice mail system when no identification number is received.

When the identification number entered by the calling party matches the PIN, the routing the call to the subscriber terminal includes sending the call to the terminating switch in association with a new call. Updated call data associated with the new call is received at the SCP, wherein the calling party number of the updated call data includes the intelligent peripheral telephone number. The terminating switch is instructed to connect the call to the subscriber terminal based on the calling party number including the intelligent peripheral telephone number.

Another aspect of the present invention provides a system for routing calls directed to a subscriber terminal in a telecommunications network, including an SCP that receives call data relating to a call to a telephone number associated with the subscriber terminal and implements a call routing service based on information in a call routing service account associated with the subscriber telephone number, and an intelligent peripheral that receives the call when the SCP implements the call routing service. The intelligent peripheral queries the calling party to select one of leaving a voice message, paging the subscriber and connecting the call to the subscriber terminal. The call data includes at least the subscriber telephone number and a calling party telephone number. When the calling party selects leaving a voice message, the intelligent peripheral connects the call through the telecommunications network to a voice mail system of the subscriber. When the calling party selects paging the subscriber, the intelligent peripheral receives a call back number from the calling party, disconnects the call, places a second call to a paging system of the subscriber. The intelligent peripheral then interacts with the paging system to initiate a page to the subscriber.

When the calling party selects connecting the call to the subscriber terminal, the intelligent peripheral queries the calling party to enter a PIN and determines authorization of the PIN entered by the calling party. When the PIN is authorized, the intelligent peripheral connects the call to the subscriber terminal, and when the PIN is not authorized, the intelligent peripheral connects the call to the voice mail system. When the intelligent peripheral connects the call to the subscriber terminal, the SCP receives updated call data, including a telephone number of the intelligent peripheral as the calling party telephone number. The SCP controls connecting the call to the subscriber terminal based on the calling party telephone number.

The system for routing calls directed to a subscriber terminal may further include a service management system (SMS), connectable to the intelligent peripheral, that receives instructions from a graphical user interface (GUI) via a packet switched data network to create and implement the PIN. The SMS transmits the PIN to the intelligent peripheral for storing and implementation with respect to authorizing the personal account number.

The intelligent peripheral may connect the call to the voice mail system when the calling party does not respond to the query to select one of leaving a voice message, paging the subscriber and connecting the call to the subscriber terminal. The intelligent peripheral may also connect the call to the voice mail system when the calling party does not respond to the query to enter the PIN.

The SCP may store at least one time period in association with the call routing service account of the subscriber and determine whether a time of the call is within the at least one time period. The time period includes a start time and an associated stop time. When the time of the call is not within the at least one time period, the SCP connects the call to the subscriber terminal without forwarding the call to the intelligent peripheral. The system for routing calls directed to a subscriber terminal may further include an SMS, connectable to the SCP, that receives instructions from a graphical user interface through a packet switched data network to create and implement the at least one time period. The SMS transmits the at least one time period to the SCP for storing and implementation.

Another aspect of the present invention provides a system for implementing a service in a telecommunications network to control routing of calls to a voice mail system of a subscriber, bypassing a subscriber terminal. The system includes multiple switches in the telecommunications network, one of which suspends a call from a calling party terminal to a telephone number associated with the subscriber terminal and, based on the subscriber telephone number, launches a trigger including call data relating to the call. The call data includes the subscriber telephone number and a calling party number. The system further includes an SCP and an intelligent peripheral, both of which are connectable to the switches. The SCP receives the trigger and determines whether the call routing service is active based on information previously stored in association with the subscriber telephone number. The intelligent peripheral stores, in association with the subscriber telephone number, a telephone number of the voice mail system, a telephone number of a paging system and a PIN. When the SCP determines one that the call routing service is inactive or that the calling party number is a telephone number of the intelligent peripheral, the SCP instructs the one of the multiple switches to connect the call to the subscriber terminal. When the SCP determines that the call routing service is active and that the calling party number is not the intelligent peripheral telephone number, the SCP instructs the switch to connect the call to the intelligent peripheral.

The intelligent peripheral queries the calling party to select one of paging the subscriber and bypassing the voice mail system. When the bypassing the voice mail system selection is received, the intelligent peripheral queries the calling party to enter an identification number. When the identification number matches the PIN, the intelligent peripheral routes the call to the subscriber telephone number through the one of the multiple switches, where the calling party number is the intelligent peripheral telephone number. When the identification number does not match the PIN, the intelligent peripheral routes the call to the voice mail telephone number. When the paging selection is received, the intelligent peripheral receives a call back number from the calling party, disconnects the call, and places a second call to the paging system telephone number. The intelligent peripheral may connect the call to the voice mail telephone number when no identification number is received.

The system for routing calls to a subscriber terminal may further include an SMS connectable to the SCP and the intelligent peripheral. The SMS is accessible by the subscriber through a GUI via a packet switched data network and through an IVR system via the telecommunications network. The PIN is determined by the subscriber and may be transmitted from the SMS to the intelligent peripheral for implementation. Also, when the intelligent peripheral places the second call to the paging system telephone number, the intelligent peripheral interacts with the paging system according to information specifically relating to the paging system of the subscriber, provided to the intelligent peripheral through the SMS.

The information previously stored in relation to the subscriber telephone number may include at least one activation schedule. The activation schedule includes a least one time period during which the call routing service is active. The activation schedule is determined by the subscriber and transmitted from the SMS to the SCP for implementation.

Yet another aspect of the present invention provides a computer readable medium for storing a computer program that routes calls directed to a subscriber terminal in a telecommunications network. The computer readable medium includes a receiving source code segment that receives call data relating to a call to a subscriber at a telephone number associated with the subscriber terminal, the call data including at least the subscriber telephone number. The computer readable medium also includes a routing source code segment that queries the calling party to select one of leaving a voice message, paging the subscriber or connecting the call to the subscriber terminal. The routing source code segment routes the call according to a response. When the calling party selects leaving a voice message, the routing source code segment connects the call to a voice mail system of the subscriber. When the calling party selects paging the subscriber, the routing source code segment receives call back information, disconnects the call and places a second call through the telecommunications network to a paging system of the subscriber that initiates a page to the subscriber.

When the calling party selects connecting the call to the subscriber terminal, the routing source code segment queries the calling party to enter a PIN. When the PIN is authorized, the routing source code segment connects the call to the subscriber terminal. When the PIN is not authorized, the routing source code segment connects the call to the voice mail system. The routing source code segment may connect the call to the voice mail system when no response is received from the calling party to the query for selecting one of leaving a voice message, paging the subscriber and connecting the call to the subscriber terminal. The routing source code segment may also connect the call to the voice mail system when no response is received from the calling party to the query for entering the PIN.

The computer readable medium may further include an activation source code segment that stores at least one activation time period, including a start time and an associated stop time. The activation source code segment determines whether a time of the call is within the at least one activation time period. When a time of the call is not within an activation time period, the routing source code segment connects the call to the subscriber terminal without querying the calling party to select one of leaving a voice message, paging the subscriber and connecting the call to the subscriber terminal.

The various aspects and embodiments of the present invention are described in detail below.

The present invention allows subscribers to route telephone calls incoming to the subscriber's telephone to voice mail, the call bypassing the subscriber's telephone line altogether. The call routing service may be implemented directly, as a single service, or as part of a Personal Call Manager (PCM) system, disclosed in U.S. patent application Ser. No. 09/619,312 to Anil Kumar BHANDARI et al., filed on Jul. 19, 2000, the disclosure of which is expressly incorporated by reference herein in its entirety, along with other telecommunication services, such as personal directories, Internet Caller Identification (ICID), Incoming Call Manager (ICM) and Outgoing Call Control (OCC) and Flexible Call Forwarding (FCF), disclosed in U.S. patent application Ser. No. 09/716,276 to Thomas ADAMS, et al., filed on Nov. 21, 2000, the disclosure of which is expressly incorporated by reference herein in its entirety.

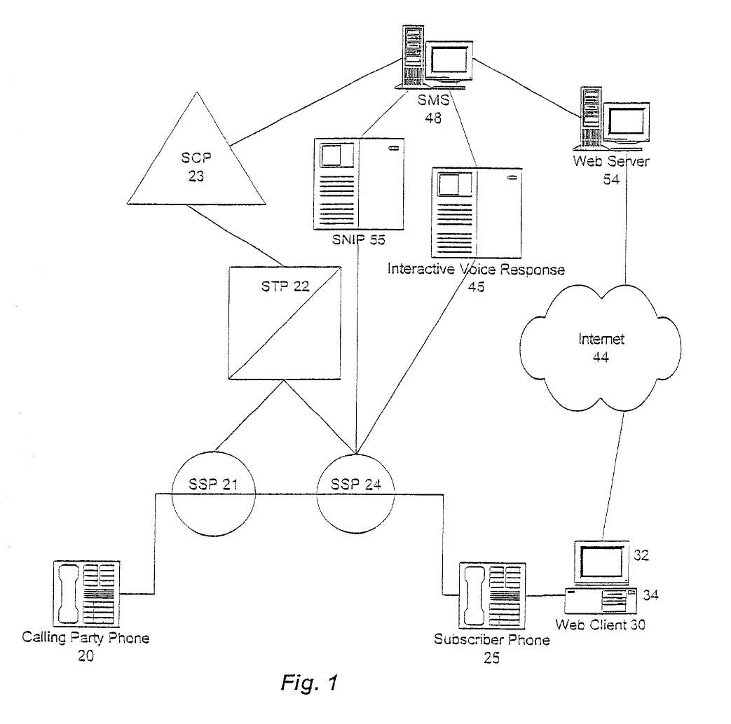

FIG. 1 illustrates an exemplary telecommunications network, in association with the present invention, for implementing the call routing service. The telecommunications network includes a calling party telephone 20, a first service switching point (SSP) 21, a second SSP 24 and a subscriber telephone 25. The subscriber telephone 25 is any type of PSTN compatible telephone, including a plain old telephone service (POTS) telephone, or a telephone in a Centrex system, a PBX system or electronic key telephone system (EKTS). The exemplary network also includes a signaling transfer point (STP) 22 and a service control point (SCP) 23.

The SSP 24 is the terminating switch or terminating central office (CO) for handling telephone calls incoming to the subscriber telephone 25. For example, when a call is placed from the calling party telephone 20 to the subscriber telephone 25, the SSP 21 is the originating switch and the SSP 24 is the terminating switch. However, as a practical matter, the SSP 24 may be both the originating switch and the terminating switch, or the call may be routed through any number of intervening switches in the PSTN, depending on the location and service of the calling party telephone 20 and the subscriber telephone 25. The SSP 21 and the SSP 24 may include, for example, 1AESS or 5ESS switches manufactured by Lucent Technologies, Inc.; DMS-100 and DMS-10 switches manufactured by Nortel Networks Corporation (Nortel); AXE-10 switches manufactured by Telefonaktiebolaget LM Ericsson, or EWSD switches available from Siemens Information and Communication Networks, Inc. The switches may utilize an AIN Release 0.1 protocol. However, embodiments of the present invention may incorporate switches, such as ATM switches, that are incorporated into any alternative telecommunications technology.

By way of example, the SCP 23 is implemented with the Bellcore Integrated Service Control Point, loaded with ISCP software Version 4.4 (or higher), available from Telecordia, Murray Hill, N.J. In an alternative embodiment of the invention, the SCP 23 may be a Lucent Advantage SCP, with software release 94, available from Lucent Technologies, Inc.

The call flow logic of the present invention may be upgraded to accommodate future AIN releases and protocols and future trigger types. Specifications of AIN Release 0.1 SSPs may be found in Telecordia Technical Reference TR-NWT-001299, Switch-Service Control Point Application Protocol Interface Generic Requirements, and Telecordia Technical Reference TR-NWT-001298, AIN Switching Systems Generic Requirements, the disclosures of which are expressly incorporated by reference herein in their entireties.

As indicated in FIG. 1, the network further includes an IVR 45 and a service node-intelligent peripheral (SN/IP) 55. For illustrative convenience, both the IVR 45 and the SN/IP 55 are shown connected to the SSP 24, although it is likely that each would be serviced by switches or hubs separate from the SSP 24. An exemplary IVR 45 is available under the trademark CONVERSANT System for IVR, Version 6.0, Update 1, provided by Lucent Technologies, Inc. The SN/IP 55 may be, for example, an Enhanced Media Resource Server (eMRS) developed by Lucent Technologies, Inc. The network incorporates any compatible stand-alone IVR, or alternatively an advanced intelligent network-intelligent peripheral (AIN-IP) or another SN/IP. In an embodiment of the invention, the IVR 45 and the SN/IP 55 may be the same platform.

A data network of the invention includes a web client 30, a web server 54 and a service management system (SMS) 48, connectable through the Internet 44. The web client 30 includes a graphical user interface (GUI) 32, i.e., a personal computer (PC), operating client software 34. Alternatively, the client software 34 can be run at the web server 54. The SMS 48 is capable of transmitting and receiving information to and from the SCP 23 and the SN/IP 55. The SMS 48 provides the subscriber interface to the SCP 23 and/or the SN/IP 55 from the subscriber phone 25 (or other DTMF telephone) through IVR 45 and from the web client 30 (or other Internet compatible device) through the web server 54, via the Internet 44. The SMS 48 also stores and distributes subscriber specific data relating to the call routing services, including account numbers, PIN numbers, paging service information and call specific data.

The web client 30 incorporates a web browser, such as Microsoft Internet Explorer, available from Microsoft Corporation, or Netscape Navigator, available from Netscape Communications Corporation. In one embodiment, the web client 30 is implemented with an IBM Pentium based PC, running the Linux operating system, available from, for example, Free Software Foundation, Inc., or the Microsoft Windows operating system, and running the Microsoft Internet Explorer, Netscape Navigator or HotJava, available from Sun Microsystems, Inc., web browser software. An embodiment of the invention includes the web server 54 running the Linux or Microsoft Windows operating system and the Apache web server software, available from the Apache Software Foundation, or the Jigsaw web server software, available from World Wide Web Consortium (W3C).

The call routing service includes numerous features in various embodiments of the invention. For example, the calling party may bypass the subscriber's voice mail service by entering a pre-established routing bypass PIN, enabling the call to connect to the subscriber telephone 25. The calling party may also elect to have the subscriber paged, entering a telephone number of where the calling party can be reached.

Furthermore, the subscriber may interactively access the call routing service by either of two methods. First, from any DTMF telephone, the subscriber dials a toll-free number, e.g., an 800 number or local service provider number, to access the IVR 45. The subscriber is prompted to enter an account number (e.g., the subscriber's telephone number), along with a password or PIN, which may or may not be the same as the bypass PIN, further discussed below. The subscriber then has the ability to change any PIN (including the account access PIN and the bypass PIN), toggle the service ON and OFF and activate or deactivate schedules. Second, the subscriber has the option to access the call routing service using the GUI 32 via the Internet 44. The subscriber is able to implement all of the IVR functions identified above, as well as build and edit activation schedules and input paging service information.

In alternative embodiments of the invention, the service provides the subscriber with additional features. For example, the subscriber may create lists of priority telephone numbers (and groups of telephone numbers) for selectively permitting incoming calls from pre-identified telephone numbers to bypass the call routing. The subscriber may also obtain call data from calls that were routed by the call routing service. The subscriber's call data may be obtained in the form of customized reports.

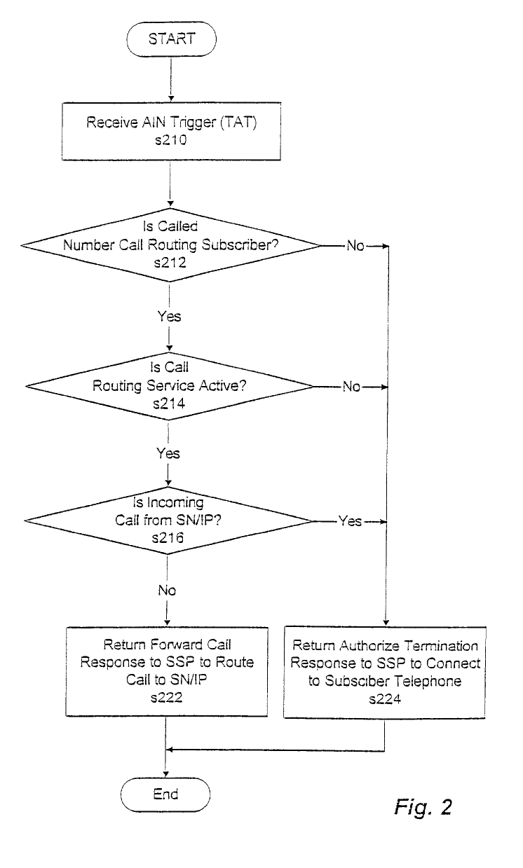

FIG. 2 is an exemplary flow diagram depicting implementation of the call routing service with respect to incoming calls, according to the service logic of the SCP 23, in one embodiment of the invention. The call originates from the calling party telephone 20, and is connected to the terminating SSP 24 through the originating SSP 21, by well known processes. At step s210, the SCP 23 receives a standard AIN query from the terminating SSP 24, notifying the SCP 23 of the attempted termination of the call to the subscriber telephone 25. The AIN query includes at least the calling party number and the called party number, which correlate to the telephone numbers of the calling party telephone 20 and the subscriber telephone 25, respectively. The AIN query, which initiates the call routing service logic at the SCP 23, may be, for example, a terminating attempt trigger (TAT). As the SCP 23 begins to process the service logic in response to the trigger, the call is suspended at the terminating SSP 24.

Based on the called party number in the AIN query, the SCP 23 determines at step s212 whether the subscriber telephone 25 subscribes to the call routing service using, for example, an internal look-up table that associates telephone numbers with AIN services. When the SCP 23 determines that the called party number does not participate in the call routing service, the call is allowed to complete at step s224. In particular, the SCP 23 returns an authorize termination response to the query of the SSP 24, which completes the call to the subscriber telephone 25. Of course, the call is subject to any other AIN services associated with the subscriber telephone 25 and the calling party telephone 20, as determined by the SCP 23, prior to authorizing completion of the call.

When the subscriber telephone 25 is determined to correspond to a call routing service subscription, the SCP 23 determines at step s214 whether the call routing functionality of the call routing service is active. The subscriber is able to turn the service ON or OFF in a number of different ways. For example, the subscriber may access the SCP 23 over the Internet 44 or the UVR 45 and simply turn the service ON, either indefinitely or until a predesignated OFF time selected by the subscriber. When the call routing service is not active, the SCP 23 returns an authorize termination response to the query of the SSP 24, allowing the call to complete to the subscriber telephone 25.

Alternatively, the call routing functionality of the service may be turned ON and OFF according to a schedule previously established and activated by the subscriber. In an embodiment of the invention, the schedule is a time of day, day of week table stored at the SCP 23 and the SMS 48. At step s214, the SCP 23 determines whether there is a match in the time of day, day of week table, based on the time and date of the call. The time of day, day of week schedule includes a table of at least one date and time period, during which the call routing functionality is active. The date and time information of the schedule is provided by the subscriber to the service provider any number of ways, including interfacing with the SCP 23 by way of SMS 48, using the Internet 44 or the IVR 45, as discussed below. When there is not a match in the time of day, day of week table, the SCP 23 determines that the call routing feature is not active. Therefore, the SCP 23 returns an authorize termination response to the query of the SSP 24, allowing the call to complete to the subscriber telephone 25.

In an embodiment of the invention (not shown in FIG. 2), when the SCP 23 determines that the call routing functionality is active, it then determines whether the calling party number has been previously identified by the subscriber as an incoming priority number, i.e., a number that is always permitted to be connected to the subscriber telephone 25 regardless of the call routing service. The SCP 23 compares the calling party number to a priority list, which may be stored as a table at the SCP 23 and associated with the subscriber's call routing service account. The priority list is pre-established by the subscriber and includes important telephone numbers, from which incoming calls are never routed to voice mail. For example, a subscriber may include a work telephone number on the priority list. Then, regardless of the time of day or the day of week, calls from the subscriber's office telephone will be allowed to complete without the calling party having to enter the bypass PIN. Another advantage of the priority list is that the subscriber may selectively enable certain calls to bypass the call routing service without having to divulge the bypass PIN to a third party.

When the routing functionality of the call routing service is active, the SCP 23 determines at step s216 whether the incoming call is coming from the SN/IP 55. The SCP 23 bases this determination on the calling party number, which is the telephone number associated with the SN/IP 55 whenever the incoming call has been placed or routed by the SN/IP 55. As discussed in detail below, the SCP 23 receives a call from the SN/IP 55 whenever the SN/IP 55 has authorized the calling party to bypass voice mail based on entry of a legitimate bypass PIN. In other words, the SCP 23 does not receive a call from the SN/IP 55 unless the calling party has successfully entered a bypass PIN. Therefore, the SCP 23 returns an authorize termination response to the query of the SSP 24 at step s224, allowing the call to complete to the subscriber telephone 25. Otherwise, the SCP 23 returns a forward call response to the SSP 24 at step s222, which instructs the SSP 24 to route the call to the SN/IP 55 for further processing.

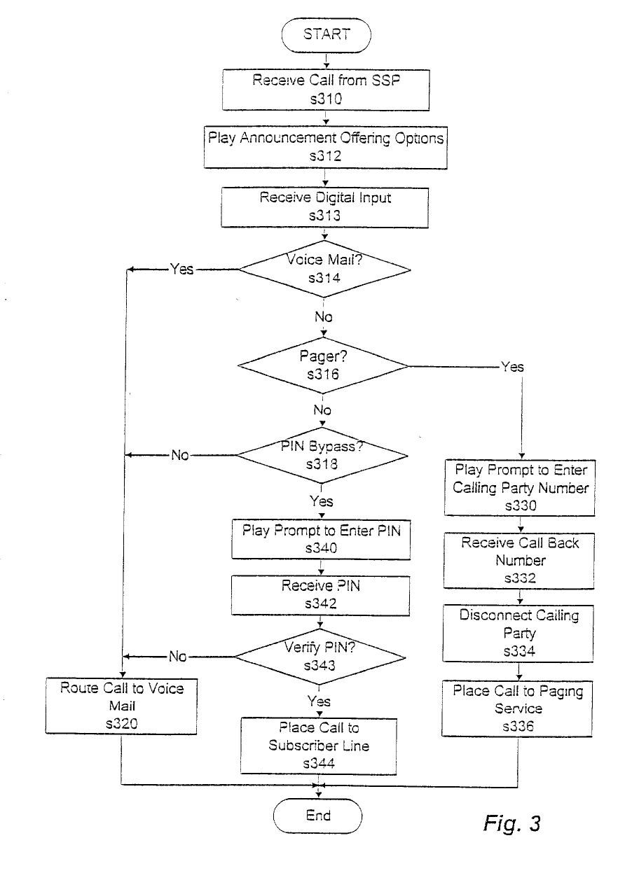

FIG. 3 is an exemplary flow diagram depicting the service logic of the SN/IP 55 once it receives the incoming call from the SSP 24, pursuant to the instructions of the SCP 23. At step s310, the SN/IP 55 receives the call from the SSP 24. As stated above, the call may be routed through any number of intervening switches and hubs between the SSP 24 and the SN/IP 55.

At step s312, the SN/IP 55 plays an announcement to the calling party, requesting the entry of digits from the calling party telephone 20, which is a DTMF telephone. An exemplary announcement requires the calling party to press 1 to enter voice mail, 2 to page the subscriber and 3 to bypass voice mail by entering a bypass PIN. The exemplary announcement states: “Your call has been forwarded to voice mail. If you wish to leave a message for the party you have called, please press 1; if you wish to page the party you have called, please press 2; if you have a PIN and wish to bypass voice mail, please press 3.”

In alternative embodiments of the invention, the subscriber may customize the call routing service with respect to the number of options provided to the calling party. For example, the subscriber may implement the call routing service without the paging option. The calling party then receives an announcement saying that the call is being routed to voice mail, unless the calling party enters a bypass PIN to connect the call. An exemplary announcement may then be as follows: “Your call has been forwarded to voice mail; please leave a message after the tone. If you wish to bypass voice mail, please press the # key and enter your personal identification number.” Likewise, the call routing service may be customized to provide only the paging alternative to voice mail.

At step s313, the SN/IP 55 receives the DTMF response entered by the calling party. When the SN/IP 55 determines at step s314 that the calling party has entered a digit requesting voice mail, or when the calling party does not enter a response within a predetermined time period, the SN/IP 55 routes the call to the subscriber's voice mail service at step s320. In particular, the SN/IP 55 sends the call to a specific voice mail mailbox associated with the subscriber. The subscriber's voice mailbox is included in a voice mail platform, which has a telephone number different from the subscriber telephone number. The SN/IP 55 identifies the telephone number of the voice mail platform, as well as the subscriber's particular mailbox, using an internal database associating the voice mail telephone number and the subscriber's mailbox number with the subscriber's account. In an alternative embodiment, the subscribers voice mail information is stored at the SCP 23, and the SN/IP 55 identifies the telephone number of the voice mail platform by querying the SCP 23 prior to routing the call to the subscriber's voice mail service at step s320. The SN/IP 55 then initiates a separate telephone call to the voice mail telephone number and requests the SSP 24 to connect the pending call with the newly initiated call using, for example, well known two B channel transfer (TBCT) methodology.

The call initiated by the SN/IP 55 is routed through the PSTN, e.g., through the SSP 24 and/or other switches, as needed, to the subscriber's voice mail platform. The SS7 signaling associated with the call to the voice mail service includes the voice mail platform telephone number as the called party number and the SN/IP 55 number as the calling party number. Therefore, no further AIN based services will be triggered at the SCP 23 in response to the call to the subscriber's voice mail. When the call to the voice mail platform is established, the original telephone call is connected using TBCT.

When the SN/IP 55 determines at step s316 that the calling party has entered a digit requesting a page, the SN/IP 55 prompts the calling party with an announcement at step s330, requesting the calling party to enter a telephone number for the subscriber to return in response to the page, e.g., the telephone number of the calling party telephone 20. The calling party may enter a call back number different from the calling party telephone number in order to receive a return call at a preferred telephone. Alternatively, the SN/IP 55 determines the calling party telephone number automatically, based on SS7 signaling data related to the call. The SN/IP 55 receives the call back number, e.g., a 10-digit telephone number, at step s332 and disconnects the calling party at step s334.

The SN/IP 55 then places a separate call to the subscriber's paging service at step s336. In particular the SN/IP 55 dials the telephone number of the subscriber's paging service, which has been previously stored at the SN/IP 55 in association with the subscriber's account number. The SN/IP 55 is configured to interact with the subscriber's paging service on behalf of the calling party. The call is placed in the PSTN, e.g., through the SSP 24 and/or other switches, as needed, to the subscriber's paging service platform. The SS7 signaling associated with the call placed to the paging service platform includes the paging service telephone number as the called party number and the SN/IP 55 number as the calling party number. Therefore, no further AIN based services will be triggered at the SCP 23 in response to the call to the subscriber's paging service.

The SN/IP 55 enters the 10-digit call back number entered by the calling party at step s332 when requested by the paging service. For example, depending on the subscriber's paging service, the SN/IP 55 may simply enter the 10-digit number upon recognizing an answer supervision signal through the PSTN indicating that the paging service has received the call. In the event the subscriber's paging service requires entry of a PIN, the SN/IP 55 may be programmed to first enter the subscriber's paging PIN, pause for a predetermined time period to allow the paging service to verify the PIN and proceed to the next scripted announcement, and then enter the 10-digit number. The subscriber's paging service places the page, notifying the subscriber of the 10-digit number.

The SN/IP 55 of the call routing service is thus able to interface with any type of paging service that the subscriber may have. The specific requirements of the various paging services must be programmed into the SN/IP 55 in conjunction with the subscriber's call routing service account number. The SN/IP 55 is thereby able to properly interact with the paging service when required.

When the SN/IP 55 determines at step s318 that the calling party has entered a digit indicating that a PIN will be provided by the calling party, the SN/IP 55 prompts the calling party to enter a bypass PIN at step s340. An exemplary announcement played by the SN/IP 55 may be as follows: “Using the touch tone numbers of your telephone, please enter your confidential PIN to bypass voice mail.” At step s342, the SN/IP 55 receives numbers entered at the calling party telephone 20. The SN/IP 55 verifies at step s343 that the number entered at the calling party telephone 20 corresponds to the bypass PIN associated with the subscriber's account using, for example, an internal look-up table containing subscriber account numbers and associated PINs.

When the entered number matches the subscriber's bypass PIN, the SN/IP 55 places a call to the subscriber telephone 25 at step s344, connecting the pending call using TBCT. In an embodiment of the invention, the AIN protocol riding on the SS7 signaling associated with the call includes the telephone number of the subscriber telephone 25 as the called party number and the SN/IP 55 telephone number as the calling party number. Therefore, the call is suspended at the terminating switch, e.g., SSP 24, which again launches a TAT query to the SCP 23 based on the subscriber telephone number, as indicated in step s210 of FIG. 2. In response, the SCP 23 executes the logic of FIG. 2, described above, except at step s216, the SCP 23 determines that the call is from the SN/IP 55 based on the calling party number. At step s224, the SCP 23 returns an authorize termination response to the SSP 24, which then connects the call to the subscriber telephone 25.

When the SN/IP 55 determines that the entered number does not match the bypass PIN associated with the subscriber's account, the SN/IP 55 plays a second announcement advising the calling party that the entered number is incorrect and connects the call to the subscriber's voice mail service at step s320. Alternatively, the SN/IP 55 provides the calling party with a second opportunity to enter the correct bypass PIN before routing the call to voice mail service.

When it is determined at step s318 that the subscriber has not entered a digit associated with voice mail, paging or PIN entry, the SN/IP 55 connects the call to the subscriber's voice mail service at step s320. Alternatively, the SN/IP 55 may repeat the announcement at step s312. The determination is made after the calling party has either entered an improper number or has not entered any number within a predetermined time period for responding to the prompt.

In an alternative embodiment of the invention, the SN/IP 55 performs a more limited role. In particular, the SCP 23 stores the subscriber's bypass PIN, along with the subscriber's activation schedules. The voice announcements are then played by the SSP 24 under the control of the SCP 23, which also analyzes the calling party's responses to the announcement. When voice mail has been requested, the SCP 23 instructs the SSP 24 to route the call to the subscriber's voice mail service. When paging has been requested, the SCP 23 instructs the SSP 24 to route the call to the SN/IP 55, which orchestrates paging the subscriber, essentially performing steps s330 to s336 of FIG. 3 (i.e., requesting a return telephone number from the calling party, disconnecting the calling party and initiating a call to the subscriber's paging service). When a bypass PIN is to be entered, the SCP 23 instructs the SSP 24 to play an announcement requesting the calling party to enter a bypass PIN. The SCP 23 then determines whether the number entered by the calling party in response matches the bypass PIN stored in association with the subscriber's account. When the number matches the bypass PIN, the SCP 23 instructs the SSP 24 to connect the call between the calling party telephone 20 and the subscriber telephone 24. When the number does not match the bypass PIN, the SCP 23 instructs the SSP 24 to route the call to the subscriber's voice mail service.

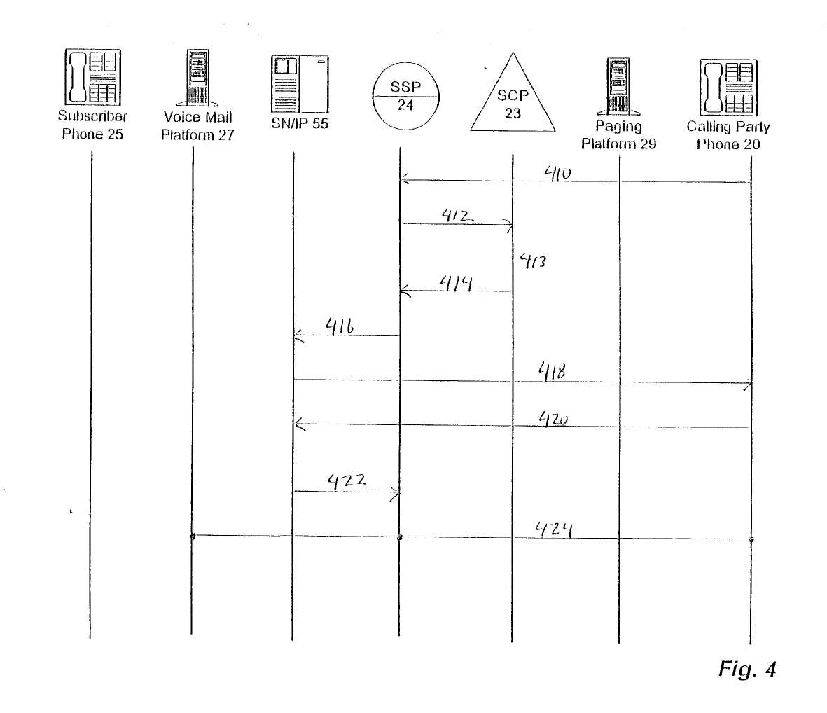

FIG. 4 is an exemplary call routing service call flow diagram depicting the process of routing an incoming telephone call to the subscriber's voice mail service. In other words, FIG. 4 shows the situation in which the SN/IP 55 receives a request for voice mail in response to the announcement played at step s312 of FIG. 3.

At step 410, a call placed from the calling party telephone 20 to the subscriber telephone 25 is suspended at the terminating SSP 24. For convenience, FIG. 4 does not show the routing of the call from the calling party telephone 20 to the SSP 24, which may include a separate originating switch, e.g., SSP 21, as well as any number of intervening switches in the PSTN. At step 412, the SSP 24 launches a TAT query to the SCP 23; the query includes the calling party telephone number and the called party telephone number. At step 413, the SCP 23 executes the application logic discussed above with respect to FIG. 2. In the example shown by FIG. 4, the SCP 23 determines at step 413 that the called party number is the subscriber telephone number, the call routing service is active, and the calling party number is not the telephone number of the SN/IP 55. The SCP 23 therefore instructs the SSP 24 to forward the telephone call to the SN/IP 55 at step 414.

The SN/IP 55 receives the call from the SSP 24 at step 416 and plays an announcement to the calling party 20 at step 418. The announcement provides the calling party three choices, as discussed with respect to step s312 of FIG. 3. The calling party can elect to enter voice mail, to page the subscriber, or to bypass voice mail using a bypass PIN. In the example depicted in FIG. 4, the calling party enters a request for voice mail in response to the announcement played by the SN/IP 55 at step 420.

The SN/IP 55 then routes the call to the voice mail platform 27 through the PSTN, for example, sending the call back through the SSP 24 at step 422. FIG. 4 indicates the final routing connection between the calling party telephone 20 and the subscriber's voice mail platform 27 at step 424, showing the call originating from the calling party telephone 20 and passing directly through the SSP 24. However, the routing of the call from the SN/IP 55 to the voice mail platform 27 may include any combination of switches in the PSTN. In an embodiment of the invention, the call is connected directly to the subscriber's voice mail box to receive the calling party's message. In other words, the calling party is not queried to enter the subscriber's mailbox number, for example, but simply is asked to leave a message for the subscriber.

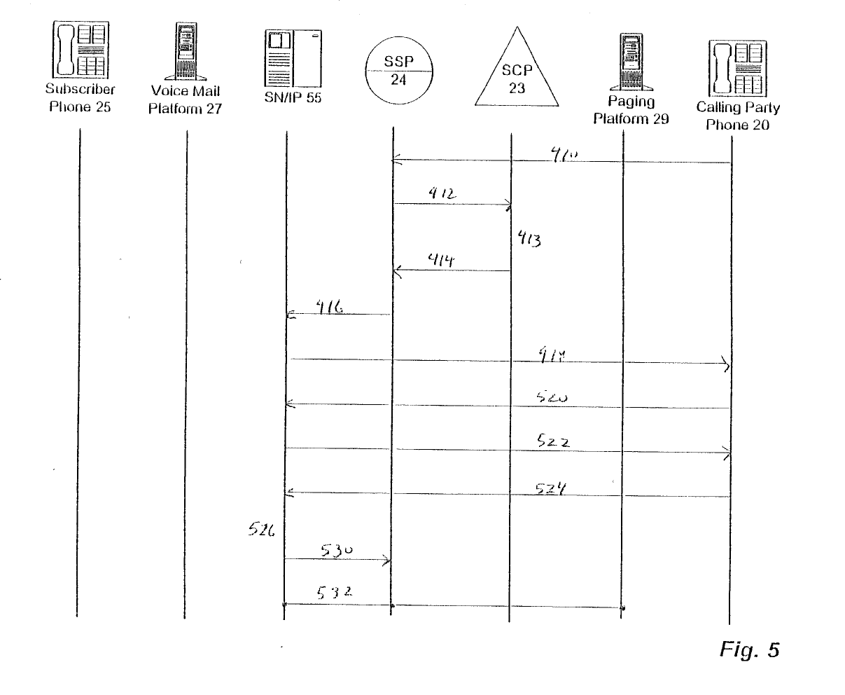

FIG. 5 is an exemplary call routing service call flow diagram depicting the process of having the subscriber paged in response to an incoming telephone call to the subscriber telephone 25. The telephone call is initially handled according to steps 410-418, as described above. However, FIG. 5 shows the situation in which the SN/IP 55 receives an entry requesting paging at step 520 in response to the announcement played at step 418, indicating that the calling party wishes to have the subscriber paged.

At step 522 the SN/IP 55 plays an announcement asking the calling party to enter a 10-digit telephone number, which will be included in the page. The calling party enters the 10-digit number at step 524. At step 526 the SN/IP 55 disconnects the calling party telephone, terminating the telephone call. The SN/IP 55 places a separate telephone call to the subscriber's paging service, previously identified by the subscriber and stored at the SN/IP 55, to initiate a page on behalf of the calling party. The call is placed in the PSTN, as indicated at step 530, by the SN/IP 55 connecting to the SSP 24, although calls from the SN/IP 55 do not necessarily involve the SSP 24. The SSP 24 routes the call through the PSTN using additional switches, if necessary, resulting in the final connection between the SN/IP 55 and the paging platform 29, shown at step 532. Because the called party number is not the subscriber telephone number, the SCP 23 is not involved in directing the call from the SN/IP 55 to the paging platform 29 pursuant to an AIN based telephony service.

Once connected to the paging platform 29, the SN/IP 55 identifies the subscriber paging service account and provides the 10-digit number entered by the calling party at step 524, in accordance with the specific requirements of the subscriber's paging service. The SN/IP 55 disconnects from the paging platform 29, which proceeds to page the subscriber according to the particulars of the subscriber's paging service. Ultimately, when responding to the page, the subscriber receives the 10-digit telephone number entered by the calling party.

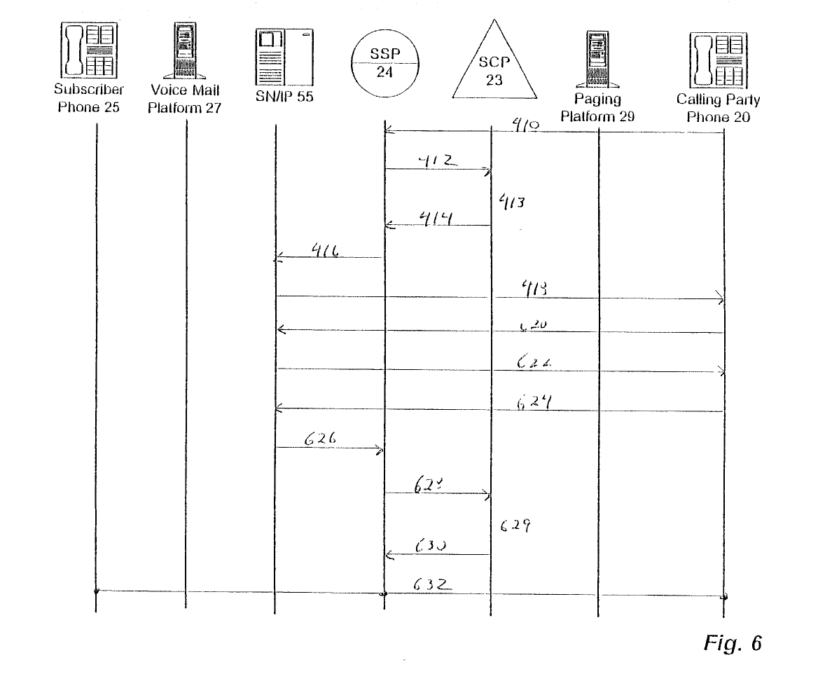

FIG. 6 is an exemplary call routing service call flow diagram depicting the process of bypassing the routing of the call to voice mail and connecting the calling party to the subscriber telephone 25. The telephone call is initially handled according to steps 410-418, as described above. However, FIG. 6 shows the situation in which the SN/IP 55 receives an entry requesting connection to the subscriber telephone 25, using a bypass PIN, at step 620 in response to the announcement played at step 418, indicating that the calling party wishes to connect to the subscriber telephone 25 by bypassing the voice mail using a PIN.

At step 622, the SN/IP 55 plays an announcement asking the calling party to enter a bypass PIN, which is a 2 to 12-digit number, for example. The SN/IP 55 receives the bypass PIN at step 624 and compares the numbers entered at the calling party telephone 20 with the previously established bypass PIN, stored in the SN/IP 55 in association with the subscriber's account.

When the SN/IP 55 determines that the entered numbers match the stored bypass PIN, it places a call to the subscriber telephone 25, connecting the newly placed call with the pending call to the subscriber telephone number using TBCT, indicated at step 626. For convenience, it is assumed in FIG. 6 that the SSP 24 is both the originating switch for the SN/IP 55 and the terminating switch for the subscriber telephone 25. In its capacity as the terminating switch, the SSP 24 suspends the call placed by the SN/IP 55 and launches a TAT trigger to the SCP 23 at step 628 based on the called party number being the subscriber telephone number. The TAT includes the subscriber telephone number as the called party telephone number and the SN/IP 55 telephone number as the calling party telephone number.

At step 629, the SCP 23 processes the call information as described in step 413, which includes the logic shown in the flow chart of FIG. 2. The SCP 23 determines that the call originated from the SN/IP 55, as opposed to the calling party telephone 20, based on the calling party number and accordingly instructs the SSP 24 to connect the call at step 630 (e.g., steps s216 and s224 of FIG. 2). The SCP 23 is thus not encumbered by orchestrating the playing of announcements to the calling party or processing the various responses. The SCP 23 simply connects all calls from the SN/IP 55 to the subscriber telephone 25. The final connection between the calling party telephone 20 and the subscriber telephone 25 through the SSP 24 is shown at step 632.

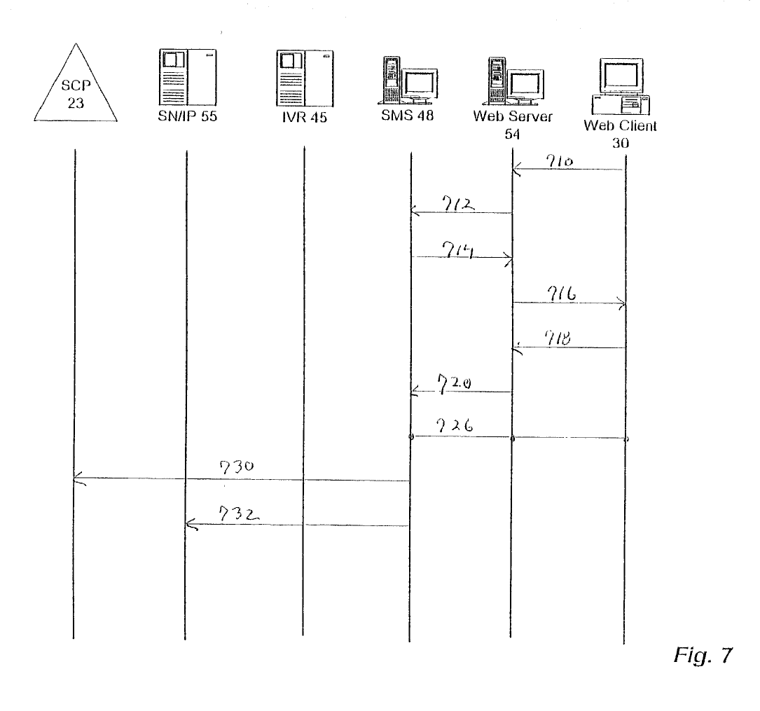

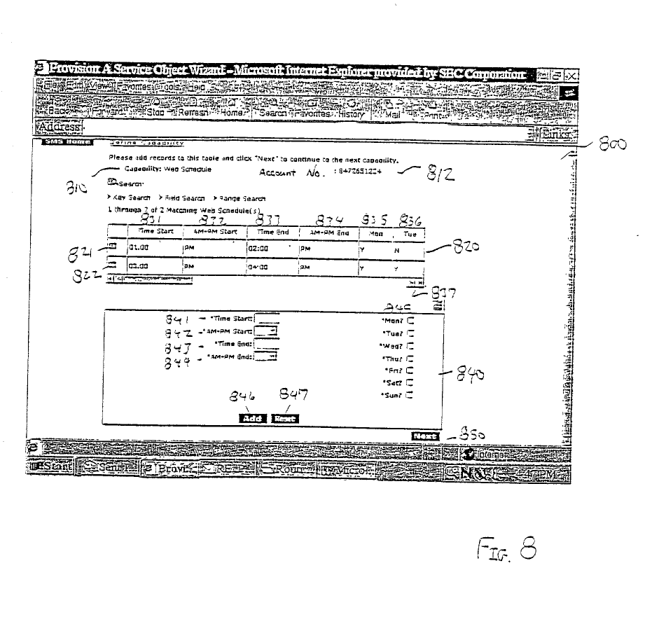

As stated above, the call routing service enables interaction with the subscriber over the Internet 44 and the IVR 45. FIG. 7 is a call flow diagram depicting an exemplary interaction between the subscriber and the call routing service by accessing the SMS 48 over the Internet 44. The subscriber accesses a unique uniform resource locator (URL) associated with the service provider. The URL is an address that identifies the appropriate protocol for communicating with the service over the Internet 44. When the subscriber accesses the Internet 44, the web server 54 provides call routing service web screens, based on data retrieved from the SMS 48, to be displayed at the GUI 32. An example of a call routing service web screen is shown in FIG. 8. In an alternative embodiment, the call routing service may be accessed via the Internet 44 through the PCM service, described in U.S. patent application Ser. No. 09/619,312 to Anil Kumar BHANDARI et al., filed on Jul. 19, 2000.

At step 710 of FIG. 7, the subscriber connects from the web client 30 to the web server 54 through the Internet 44. The web server 54 then connects to the SMS 48, which stores and updates the call routing service data, as well as associated authentication data, at step 712. Once connected, the SMS 48 instructs the web server 54 at step 714 to authenticate the subscriber. Accordingly, the web server 54 queries the subscriber at step 716 to enter the authentication data, which may include an account number and an associated account access PIN. The account access PIN may be the same series of numbers as the bypass PIN, which enables select calling parties to bypass routing to the voice mail or paging services. Alternatively, the account access PIN and the bypass PIN are different to ensure that individuals, other than the subscriber, who have access to the bypass PIN, are not able to access the account over the Internet 44 and change the various settings, including, for example, the account access PIN. The subscriber is able to interactively change all PIN numbers associated with the call routing service account over the Internet 44, as well as through the IVR 45.

The subscriber authentication responses are received at the web server 54 at step 718, and forwarded to the SMS 48 for authentication at step 720. Alternatively, web server 54 may perform the authentication step based on information sent from the SMS 48. The SMS 48 retrieves the account number and associated account access PIN to confirm that the subscriber is authorized to access the account information.

Upon successful authentication, the SMS 48 retrieves the subscriber's current calling routing service data from an associated internal or external database. The data includes, for example, the activation status of the service, the active bypass PIN(s), the current schedule information, and the current paging service information. An interactive connection is maintained at step 726 among the SMS 48, the web server 54 and the web client 30, enabling the subscriber to access, review and update the call routing service data. For example, the web server 54 receives HTTP messages from the subscriber at web client 30 and provides HTML web pages in response to the subscriber's input. The web pages relate to the subscriber's call routing service, as indicated by the SMS 48.

When the subscriber updates or adds information, or changes the activation status of the service, the SMS 48 updates the SCP 23 at step 730 and the SN/IP 55 at step 732, accordingly. For example, the subscriber may create a new activation schedule to be implemented immediately. After creating the schedule, the subscriber clicks on “next” or “continue” displayed on the web screen, which creates a service order to implement the change. The subscriber may first be advised that a service order is about to be issued and given the opportunity to confirm the action prior to implementation. When the subscriber confirms the service order, the SMS 48 sends the new schedule information to the SCP 23. The subscriber may similarly implement changes to the data accessible by the SN/IP 55, such as the bypass PIN and the type of paging service, along with the corresponding interactive paging scripts. In an alternative embodiment, whenever the subscriber logs off of the call routing service web site, disconnecting the web sever 54 from the SMS 48, the SMS 48 automatically updates the SCP 23 and the SN/IP 55. In any case, the SCP 23 and the SN/IP 55 store the updated information received from the SMS 48 for immediate implementation.

In an alternative embodiment, after a successful authentication, the SMS 48 queries the SCP 23 to retrieve the data associated with the subscriber's call routing service account, including schedules and activation status. The SMS 48 may also query the SN/IP 55 for additional subscriber data, including the currently active bypass PIN and paging service data. The subscriber data stored at the SN/IP 55 may also include records of all incoming calls that attempted connection to the subscriber telephone 25 during an activation period of the call routing service, as well as the eventual disposition of each call (e.g., routing to voice mail, paging the subscriber or connecting the call pursuant to entry of a bypass PIN). The SN/IP 55 data would enable the subscriber to populate reports related to the call routing service.

FIG. 8 is an exemplary web page provided to the web client 30 by the SMS 48 by way of web server 54, according to an embodiment of the present invention. The actual layout of the web pages, as well as the specific options made available to the subscriber on the web pages, may vary. In particular, FIG. 8 is an exemplary web page 800 displayed at GUI 32 when the subscriber has been successfully authenticated. The web page 800 enables the subscriber to create, edit, delete and implement activation schedules associated with the call routing service, as indicated by the capability header 810. The web page 800 includes the subscriber's account number 812, which is the subscriber's telephone number. The interaction with the subscriber may be provided on a secure window, incorporating, for example, secure sockets layer (SSL) protocol, developed by Netscape Communications.

Table 820 shows the existing activation schedules available to the subscriber. The exemplary web page 800 indicates that the subscriber has created two activation schedules, 821 and 822. The activation schedules are defined by a start time 831/832, an end time 833/834, and the days of the week during which the respective schedules apply. The web page 800 shows only columns 835 and 836 for Monday and Tuesday, respectively. The subscriber is able to scroll horizontally to the remaining days of the week using the positioning arrow 837 located at the bottom, right side of the table 820.

The activation schedule 821 shows a 1:00 a.m. start time and a 2:00 p.m. end time. The activation schedule 821 is applicable on Mondays, indicated by the Y in column 835, but not on Tuesdays, indicated by the N in column 836. The activation schedule 822 shows a 3:00 p.m. start time and a 4:00 p.m. end time. The activation schedule 822 is applicable on Mondays and Tuesdays, indicated by the Ys in columns 835 and 836, respectively. Schedules 821 and 822 would likewise be active for any additional day of the week in which a Y is placed in the corresponding column. To edit the activation schedules shown in table 820, the subscriber simply clicks on the entry to be edited and types in the new data. For example, if the subscriber wishes to apply activation schedule 821 to Tuesdays, the subscriber clicks on the N in column 836, and enters a Y in its place.

In order to implement the activation schedules as depicted in table 820, the subscriber simply selects the “next” key 850, which creates a corresponding work order, as described above, and moves the subscriber to the next predetermined web page. The information in table 820 is sent by way of the web server 54 to the SMS 48, which updates the SCP 23 for immediate implementation.

In order to create a new activation schedule, the subscriber fills in the information in the box 840. The subscriber enters the start time in field 841, identifies morning or afternoon for the start time in field 842, enters the end time in field 843 and identifies morning or afternoon for the end time in field 844. The subscriber then clicks on the small boxes in column 845 to indicate the days of the week, Monday through Sunday, the new activation schedule is to be applied by a check mark. Upon completion, the subscriber selects the “add” key 846 to implement the new activation schedule, which then automatically appears in sequential order below the activation schedule 822 in table 820. When the subscriber selects the “reset” key 847 on web page 800, any information entered into the fields of the box 840 is deleted, and the subscriber may start over entering schedule data.

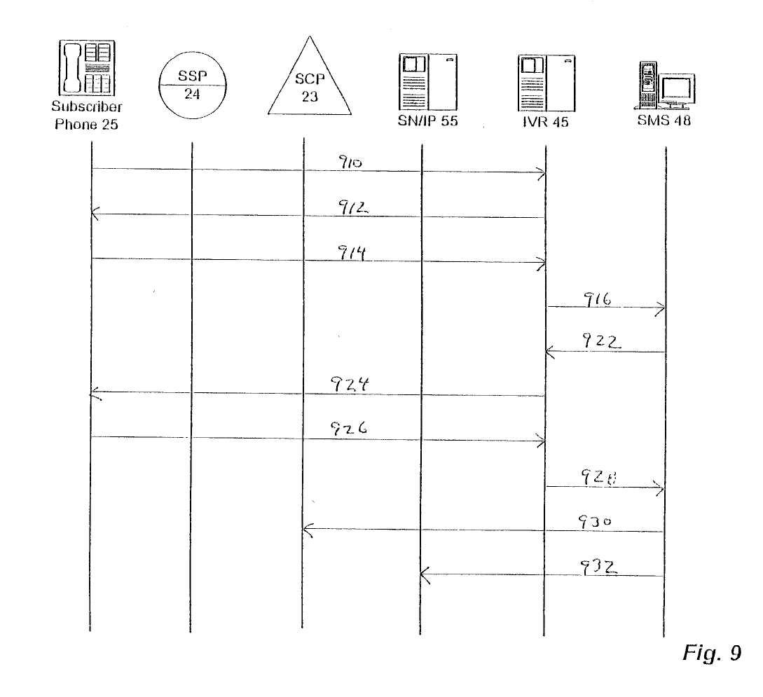

As stated above, the information available to the subscriber over the Internet 44, described with respect to FIG. 7 is likewise available to the subscriber through the IVR 45. Exemplary steps by which the subscriber interacts with the call routing service through the IVR 45 are shown in FIG. 9. Access through the IVR 45 is limited in that the subscriber cannot actually create or view the activation schedules using the IVR 45. However, the subscriber can access all other features of the call routing service, including changing the account access PIN, changing the bypass PIN, toggling the service ON or OFF and activating/deactivating pre-established schedules for particular days of the week.

Referring to FIG. 9, the subscriber calls a toll free number from the subscriber telephone 25, which accesses the IVR 45 through the PSTN, shown at step 910. Although FIG. 9 depicts the call originating from the subscriber telephone 25, the subscriber may access the IVR 45 from any DTMF telephone in the PSTN. The IVR 45 receives the call and initiates a request for various authentication information, such as the subscriber account number (e.g., the telephone number of the subscriber telephone 25) and a related account access PIN, at step 912. (Although communications between the subscriber telephone 25 and the IVR 45 pass various switches in the PSTN, possibly including the SSP 24, this step is omitted for convenience.) The account number and the account access PIN, which may be the same as the account number and account access PIN used to access the call routing service via the Internet 44, are entered by the subscriber using the touch tones of the subscriber telephone 25 at step 914. The pre-programmed voice announcements for this aspect of the invention reside in the IVR 45, and implementation of the voice announcements is well known. The IVR 45 forwards the information to the SMS 48 at step 916 for authentication.

After authentication, the SMS 48 retrieves the current service data for the identified call routing service account, including the current schedules, bypass PIN and paging service information, from an associated database. In an alternative embodiment, the SMS 48 retrieves the current service data from the SCP 23 and the SN/IP 55, as discussed above. The SMS 48 then provides the IVR 45 with the data specific to the subscriber account at step 922. The IVR 45 verbally recites a menu of options to the subscriber at step 924 based on the information received from the SMS 48. For example, the subscriber may interactively change the bypass PIN using the touch tone keys. The subscriber would be prompted to enter the existing bypass PIN and the new bypass PIN, with a second entry for confirmation. Also, the subscriber may activate or deactivate the previously built schedule, as indicated in table 820 of FIG. 8, for example. In an alternative embodiment, if the subscriber has previously built a variety of schedules, the subscriber may selectively activate one or more of the schedules, as desired, over the IVR 45.

The information is provided by the subscriber in response to the voice generated options of the IVR 45 at step 926, which forwards the information to the SMS 48 at step 928. The SMS 48 accordingly updates the subscriber's account at the SCP 23 and the SN/IP 55 at step 930 and 932, respectively. The SCP 23 and the SN/IP 55 then handle telephone calls to the subscriber telephone 25 according to the updated account information.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for routing calls directed to a subscriber terminal in a telecommunications network, the method comprising:
receiving call data relating to a call to a subscriber at a telephone number associated with the subscriber terminal, the call data comprising the subscriber telephone number;
querying the calling party to select one of leaving a voice message, paging the subscriber and connecting the call to the subscriber terminal;
when the calling party selects leaving a voice message, connecting the call through the telecommunications network to a voice mail system of the subscriber;
when the calling party selects paging a subscriber, receiving call back information, disconnecting the call and placing a second call through the telecommunications network to a paging system of the subscriber that initiates a page to the subscriber; and
when the calling party selects connecting the call to the subscriber terminal, querying the calling party to enter a personal identification number;
when the personal identification number is authorized, connecting the call to the subscriber terminal; and
when the personal identification number is not authorized, connecting the call through the telecommunications network to the voice mail system.

2. The method for routing calls directed to a subscriber terminal in a telecommunications network according to claim 1, further comprising:
storing at least one activation time period, comprising a start time and an associated stop time;
determining whether a time of the call is within the at least one activation time period; and
when the time of the call is not within the at least one activation time period, connecting the call to the subscriber terminal without querying the calling party to select one of leaving a voice message, paging the subscriber and connecting the call to the subscriber terminal.

3. The method for routing calls directed to a subscriber terminal in a telecommunications network according to claim 1, further comprising:
connecting the call to the voice mail system when no response to the querying the calling party to select one of leaving a voice message, paging the subscriber and connecting the call to the subscriber terminal is received.

4. The method for routing calls directed to a subscriber terminal in a telecommunications network according to claim 1, further comprising:
connecting the call to the voice mail system when no response to the querying the calling party to enter the personal identification number is received.

5. A method for implementing a service in a telecommunications network to control routing of calls to a voice mail service of a subscriber, bypassing a subscriber terminal, the method comprising:
suspending at a terminating switch in the telecommunications network a call from a calling party terminal to a telephone number of the subscriber terminal;
receiving at a service control point call data relating to the call, the call data comprising the subscriber telephone number and a calling party number;
when the call routing service is not active, connecting the call to the subscriber terminal;
when the call routing service is active, determining whether the calling party number comprises a telephone number of an intelligent peripheral;
when the calling party number comprises the intelligent peripheral telephone number, connecting the call to the subscriber terminal;
when the calling party number does not comprise the intelligent peripheral telephone number, forwarding the call to the intelligent peripheral;
querying the calling party to select one of paging the subscriber and bypassing the voice mail system by entering an identification number;
when no selection is received, routing the call to the voice mail system;
when the paging selection is received, receiving a call back telephone number from the calling party, disconnecting the call, placing a second call to a paging system of the subscriber and interacting with the paging system to page the subscriber; and
when the bypassing the voice mail system selection is received, routing the call to the subscriber terminal when the identification number entered by the calling party matches a previously determined personal identification number of the subscriber, and routing the call to the voice mail system when the identification number entered by the calling party does not match the personal identification number.

6. The method for implementing a service in a telecommunications network to control routing of calls to a voice mail system according to claim 5, further comprising:
routing the call through the telecommunications network to the voice mail system when no identification number is received.

7. The method for routing calls to a subscriber terminal in a telecommunications network according to claim 5, when the identification number entered by the calling party matches the personal identification number, the routing the call to the subscriber terminal comprising:
sending the call to the terminating switch in association with a new call;
receiving at the service control point updated call data associated with the new call, wherein the calling party number of the updated call data comprises the intelligent peripheral telephone number; and
instructing the terminating switch to connect the call to the subscriber terminal based on the calling party number comprising the intelligent peripheral telephone number.

8. A system for routing calls directed to a subscriber terminal in a telecommunications network, the system comprising:
a service control point that receives call data relating to a call to a telephone number associated with the subscriber terminal and implements a call routing service based on information in a call routing service account associated with the subscriber telephone number, the call data comprising at least the subscriber telephone number and a calling party telephone number; and
an intelligent peripheral that receives the call when the service control point implements the call routing service and queries the calling party to select one of leaving a voice message, paging the subscriber and connecting the call to the subscriber terminal;
when the calling party selects leaving a voice message, the intelligent peripheral connecting the call through the telecommunications network to a voice mail system of the subscriber;
when the calling party selects paging the subscriber, the intelligent peripheral receiving a call back number from the calling party, disconnecting the call, placing a second call to a paging system of the subscriber, and interacting with the paging system to initiate a page to the subscriber;
when the calling party selects connecting the call to the subscriber terminal, the intelligent peripheral querying the calling party to enter a personal identification number from the calling party and determining authorization of the personal identification number entered by the calling party; and
when the personal identification number is authorized, the intelligent peripheral connecting the call to the subscriber terminal, and when the personal identification number is not authorized, the intelligent peripheral connecting the call to the voice mail system.

9. The system for routing calls directed to a subscriber terminal in a telecommunications network according to claim 8, when the intelligent peripheral connects the call to the subscriber terminal, the service control point receiving updated call data comprising a telephone number of the intelligent peripheral as the calling party telephone number; and
the service control point controlling connecting the call to the subscriber terminal based on the calling party telephone number.

10. The system for routing calls directed to a subscriber terminal in a telecommunications network according to claim 8, the service control point storing at least one time period in association with the call routing service account of the subscriber and determining whether a time of the call is within the at least one time period, the at least one time period comprising a start time and an associated stop time; and
when the time of the call is not within the at least one time period, the service control point connecting the call to the subscriber terminal without forwarding the call to the intelligent peripheral.

11. The system for routing calls directed to a subscriber terminal in a telecommunications network according to claim 10, further comprising:
a service management system, connectable to the service control point, that receives instructions from a graphical user interface via a packet switched data network to create and implement the at least one time period, the service management system transmitting the at least one time period to the service control point for storing and implementation.

12. The system for routing calls directed to a subscriber terminal in a telecommunications network according to claim 8, the intelligent peripheral connecting the call to the voice mail system when the calling party does not respond to the query from the intelligent peripheral to select one of leaving a voice message, paging the subscriber and connecting the call to the subscriber terminal.

13. The system for routing calls directed to a subscriber terminal in a telecommunications network according to claim 8, the intelligent peripheral connecting the call to the voice mail system when the calling party does not respond to the query from the intelligent peripheral to enter the personal identification number.

14. The system for routing calls directed to a subscriber terminal in a telecommunications network according to claim 8, the system further comprising:
a service management system, connectable to the intelligent peripheral, that receives instructions from a graphical user interface via a packet switched data network to create and implement the personal identification number, the service management system transmitting the personal identification number to the intelligent peripheral for storing and implementation with respect to authorizing the personal account number.

15. A system for implementing a service in a telecommunications network to control routing of calls to a voice mail system of a subscriber, bypassing a subscriber terminal, the system comprising:
a plurality of switches in the telecommunications network, one of the plurality of switches suspending a call from a calling party terminal to a telephone number associated with the subscriber terminal and, based on the subscriber telephone number, launching a trigger comprising call data relating to the call, the call data comprising the subscriber telephone number and a calling party number;
a service control point connectable to the one of the plurality of switches, the service control point receiving the trigger and determining whether the call routing service is active based on information previously stored in association with the subscriber telephone number; and
an intelligent peripheral connectable to the one of the plurality of switches, the intelligent peripheral storing in association with the subscriber telephone number a telephone number of the voice mail system, a telephone number of a paging system and a personal identification number;
when the service control point determines one of the call routing service being inactive and the calling party number being a telephone number of the intelligent peripheral, the service control point instructing the one of the plurality of switches to connect the call to the subscriber terminal;
when the service control point determines that the call routing service is active and that the calling party number is not the intelligent peripheral telephone number, the service control point instructing the one of the plurality of switches to connect the call to the intelligent peripheral;
the intelligent peripheral querying the calling party to select one of paging the subscriber and bypassing the voice mail system;
when the bypassing the voice mail system selection is received, the intelligent peripheral querying the calling party to enter an identification number;
when the identification number matches the personal identification number, the intelligent peripheral routing the call to the subscriber telephone number through the one of the plurality of switches, the calling party number being the intelligent peripheral telephone number; and
when the identification number does not match the personal identification number, the intelligent peripheral routing the call to the voice mail telephone number.

16. The system for implementing a service in a telecommunications network to control routing of calls to a voice mail system according to claim 15, when the paging selection is received, the intelligent peripheral receiving a call back number from the calling party, disconnecting the call, and placing a second call to the paging system telephone number.

17. The system for routing calls to a subscriber terminal in a telecommunications network according to claim 16, further comprising:
a service management system connectable to the service control point and the intelligent peripheral, the service management system being accessible by the subscriber through a graphical user interface via a packet switched data network and through an interactive voice response system via the telecommunications network.

18. The system for implementing a service in a telecommunications network to control routing of calls to a voice mail system according to claim 15, the intelligent peripheral routing the call to the voice mail telephone number when no identification number is received.

19. The system for routing calls to a subscriber terminal in a telecommunications network according to claim 17, when the intelligent peripheral places the second call to the paging system telephone number, the intelligent peripheral interacting with the paging system according to information specifically relating to the paging system of the subscriber, provided to the intelligent peripheral via the service management system.

20. The system for routing calls to a subscriber terminal in a telecommunications network according to claim 17, the information previously stored in relation to the subscriber telephone number comprising at least one activation schedule, the at least one activation schedule comprising a least one time period during which the call routing service is active.

21. The system for routing calls to a subscriber terminal in a telecommunications network according to claim 20, the at least one activation schedule being determined by the subscriber and transmitted from the service management system to the service control point for implementation.

22. The system for routing calls to a subscriber terminal in a telecommunications network according to claim 17, the personal identification number being determined by the subscriber and transmitted from the service management system to the intelligent peripheral for implementation.

23. A computer readable medium for storing a computer program that routes calls directed to a subscriber terminal in a telecommunications network, the computer readable medium comprising:
a receiving source code segment that receives call data relating to a call to a subscriber at a telephone number associated with the subscriber terminal, the call data comprising at least the subscriber telephone number; and
a routing source code segment that queries the calling party to select one of leaving a voice message, paging the subscriber and connecting the call to the subscriber terminal, and that routes the call according to a response to the querying;
when the calling party selects leaving a voice message, the routing source code segment connecting the call to a voice mail system of the subscriber;
when the calling party selects paging the subscriber, the routing source code segment receiving call back information, disconnecting the call and placing a second call through the telecommunications network to a paging system of the subscriber that initiates a page to the subscriber; and
when the calling party selects connecting the call to the subscriber terminal, the routing source code segment querying the calling party to enter a personal identification number;
when the personal identification number is authorized, the routing source code segment connecting the call to the subscriber terminal; and
when the personal identification number is not authorized, the routing source code segment connecting the call through to the voice mail system.

24. The computer readable medium for storing a computer program that routes calls directed to a subscriber terminal in a telecommunications network, according to claim 23, the computer readable medium further comprising:
an activation source code segment that stores at least one activation time period, comprising a start time and an associated stop time, and that determines whether a time of the call is within the at least one activation time period;
when a time of the call is not within the at least one activation time period, the routing source code segment connecting the call to the subscriber terminal without querying the calling party to select one of leaving a voice message, paging the subscriber and connecting the call to the subscriber terminal.

25. The computer readable medium for storing a computer program that routes calls directed to a subscriber terminal in a telecommunications network, according to claim 23, the routing source code segment connecting the call to the voice mail system when no response is received from the calling party to the query for selecting one of leaving a voice message, paging the subscriber and connecting the call to the subscriber terminal.

26. The computer readable medium for storing a computer program that routes calls directed to a subscriber terminal in a telecommunications network, according to claim 23, the routing source code segment connecting the call to the voice mail system when no response is received from the calling party to the query for entering the personal identification number
